(19) United States
(12) Patent Application Publication
(10) Pub. No.: US 2010/0312612 A1
(43) Pub. Date: Dec. 9, 2010

(54) MODIFICATION OF SERVICE DELIVERY INFRASTRUCTURE IN COMMUNICATION NETWORKS

(76) Inventors: Hugh Carr, County Wicklow (IE); Ekaterina Sizova, Huizen (NL)

Correspondence Address: JACOBSON HOLMAN PLLC, 400 SEVENTH STREET N.W., SUITE 600, WASHINGTON, DC, 20004, US

(21) Appl. No.: 12/734,315

(22) PCT Filed: Oct. 23, 2008
(86) PCT No.: PCT/IE2008/000108

§ 371 Date: Aug. 19, 2010

Related U.S. Application Data
(60) Provisional application No. 60/996,026, filed on Oct. 25, 2007.

(51) Int. Cl. G06Q 10/00

(52) U.S. Cl. 705/10

(57) ABSTRACT

A service management framework operates in a communication network having a service delivery infrastructure providing services to subscribers. The framework collects service delivery data from the network and analyses the data to dynamically and pre-emptively modify the service delivery infrastructure to optimise service delivery. The analysis involves performing, using subscriber profiles, subscriber segmentation to generate segmentation models representing behavioural characteristics of subscribers. It also involves deriving service predictive models from the segmentation models and collected network infrastructure data, said service predictive models correlating service demand levels and network infrastructure utilisation. The framework determines in response to the predictive models the actions to be taken. The framework manages trend and service delivery infrastructure network element objects, each trend object representing dynamic aspects of a parameter and tracking behaviour of one or more of a subscriber object, a service object, a network element object, and a segment object.

### FIELD OF THE INVENTION

The invention relates to service management in communication networks.

### Prior Art Discussion

Operators are increasingly faced with the challenge of how best to set up their network in order to satisfy dynamic service demand from their customers. This is increasingly so with the advent and introduction of more complex messaging services and architectures (e.g. in the context of IMS or the overall context of personalised messaging services and experience).

These challenges are further compounded by the fact that operators are increasingly simultaneously managing multiple heterogeneous networks such as traditional GSM, and newer IP based IMS networks.

Existing network capacity measurement systems tend to focus in isolation on measuring capacity of particular network service point sub-systems such as for example endeavouring to determine sizing/capacity of specific node(s) of an SMS sub-system, whereas the challenge the operator is facing is optimizing the entire messaging network infrastructure, including sub-systems.

The invention is directed towards providing an infrastructure for improved service management.

### SUMMARY OF THE INVENTION

According to the invention, there is provided a service management framework for operation in a communication network having a service delivery infrastructure with network elements providing services to subscribers, the service management framework comprising:
collecting means for collecting service delivery data from the network;
analysis means for analysing said data by performing the steps of:
   performing, using subscriber profiles, subscriber segmentation to generate segmentation models representing behavioural characteristics of subscribers,
   deriving service predictive models from said segmentation models and collected network infrastructure data, said service predictive models correlating service demand levels and network infrastructure utilisation, and
   determining in response to said predictive models actions to dynamically and pre-emptively modify the service delivery infrastructure of the network to optimise service delivery; and
acting means adapted to perform said actions.

In one embodiment, the analysis means is adapted to generate at least one service predictive model for each network element, group of network elements, or subscriber segment or subscriber segments.

In one embodiment, the analysis means or the collecting means is adapted to execute a set of data adapters for initial processing of collected data.

In one embodiment, the analysis means is adapted to use agreed quality of service requirements when determining an action to be implemented which may affect quality of service. In one embodiment, the analysis means is adapted to determine an action to be implemented which affects quality of service for a subscriber segment and not other subscriber segments, the determined actions being selected from one or more of re-prioritizing a subscriber's messages in delivery queues, adjusting bandwidth for a subscriber, message re-direction to particular service centres, or re-allocation of hardware resources across multiple services.

In one embodiment, said service predictive models track network infrastructure utilisation parameters including current number of active subscribers, traffic demand, projected number of active subscribers, and expected demand.

In one embodiment, the analysis means comprises means for generating network element models defining characteristics of network element configurations. Preferably, the analysis means comprises means for performing analysis of relationships between said segmentation, service predictive, and network element models. In one embodiment, the analysis means comprises means for managing subscriber objects each including at least a subscriber identifier, and service objects each defining a service, and for managing associations between these objects to develop the models.

In one embodiment, the analysis means is adapted to manage subscriber segment objects, each defining a subscriber behaviour segment, and to manage network element objects each defining a network element of the service delivery infrastructure and its associations with service objects.

In one embodiment, the analysis means is also adapted to manage trend objects, each trend object representing dynamic aspects of at least one parameter and being executed to track behaviour of a subscriber object, a service object, a network element object, and a segment object.

Preferably, at least one trend object tracks a basic trend and at least one trend object tracks a derived trend including service demand which is derived from at least one basic trend object.

In one embodiment, each segmentation model comprises a segment object and related subscriber objects and the subscriber objects are related to trend objects representing subscriber behavioural characteristics.

In one embodiment, a service predictive model comprises a segment object and related trend objects.

In one embodiment, the analysis means and the acting means comprise means for determining if a subscriber exceeds fair usage beyond a flat fee tariff, and for performing an automatic action of re-prioritizing that subscriber's messages in delivery queues, or adjusting bandwidth for the subscriber.

In one embodiment, the analysis means and the acting means comprise means for performing automatic subscriber re-provisioning including changing a subscriber's service centre address.

In another embodiment, the analysis means and the acting means comprise means for notifying a subscriber of an action which has been performed or needs to be performed by the subscriber. In one embodiment, the analysis means and the acting means comprise means for performing automatic pushing of information to subscriber devices. In one embodiment, the analysis means and the acting means comprise means for performing automatic pushing of information for Over-the-Air device re-configuration.

In one embodiment, the analysis means and the acting means comprise means for performing automatic re-configuration of a network element.

In one embodiment, the analysis means and the acting means comprise means for performing automatic re-configuration of a network element to operate with a different technology stack, such as transfer from GSM to IMS (SIP enabled).

In one embodiment, the analysis means and the acting means comprise means for automatically adjusting operation of a network element for service delivery optimisation. In one embodiment, the analysis means and the acting means comprise means for automatically adjusting network control parameters including message delivery attempts per time period or number of active subscribers.

In one embodiment, the control parameters are associated with a license for a network element or group of network elements.

In one embodiment, the analysis means and the acting means comprise means for performing automatic re-configuration by activating software resident on network element hardware servers to achieve intelligent service provisioning.

In one embodiment, the analysis means and the acting means comprise means for performing automatic re-configuration by installing software on network element hardware servers to achieve intelligent service provisioning.

In one embodiment, the analysis means and the acting means comprise means for performing automatic activation of hardware servers to augment processing capacity of certain network elements.

In one embodiment, the analysis means and the acting means comprise means for performing re-configuration of a server to allow or prioritise delivery of content from or to a content provider or a subscriber.

In one embodiment, the analysis means and the acting means comprise means for performing modification of a network element or link settings including allocated in-flight capacity, content validity periods, network connections, network connection bandwidth, or quality-of-service parameters.

In one embodiment, the collecting means comprises an interface for receiving network element transactional data including call detail record (CDR) streams.

In one embodiment, the collecting means comprises an interface for receiving network performance objects containing information concerning network element utilisation, including SNMP performance objects.

In one embodiment, the collecting means comprises an interface for receiving network element monitoring information.

In one embodiment, the collecting means comprises means for receiving real time data feeds.

According to another aspect, the invention provides a computer readable medium comprising software code for performing operations of a framework of any embodiment described above when executing on one or more digital processors.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:

FIG. 1 is a block diagram showing an intelligent framework of the invention for service management;

FIG. 2 is a high level view illustrating operation of the intelligent framework for service management in a communications network, and showing a SIP/GSM delivery context;

FIG. 3 shows a configuration of the framework, for service centres;

FIG. 4 is a diagram illustrating licence management by the framework;

FIG. 5 is a diagram showing provisioning of subscriber-related service information;

FIG. 6 shows major aspects of databases of the intelligent service management framework;

FIG. 7 shows sample call flows for operation of the framework, this drawing being spread as FIGS. 7(A) and 7(B) across two pages, and being henceforth referred to as FIG. 7;

FIG. 8 is a high level data model for operation of the framework;

FIG. 9 is a flow diagram illustrating operation of the framework in a campaign management example; and

FIG. 10 is a flow diagram showing Service Level Agreement (SLA) management.

### DESCRIPTION OF THE EMBODIMENTS

An intelligent service management framework of the invention collects network usage data, analyses this data, and then dynamically acts in response to the data in an automatic feedback loop to modify service delivery infrastructure in order to optimise service delivery. The framework is dynamically adaptive to service usage. The framework is particularly important for network operators as it provides the ability to automatically adhere to or manage agreements such as service level agreements (“SLA”) and licenses governing capacity concerning factors such as numbers of active subscribers and throughput of network elements. Also, because the framework optimises the technical capability of the network the operator can optimise the number of active subscribers and the throughput of network elements. Also, they can optimise quality of service (“QoS”) for services provided to the active subscribers. The framework executes segmentation and service predictive models to dynamically and pre-emptively modify the service delivery infrastructure of the network to optimise service delivery. This is described in more detail below.

In the following detailed description of the framework the subscriber represents the entity that uses a service, i.e. has some form of subscription. The subscriber can be either a mobile user or an application (with a subscription service). The subscriber consumes various products and services, offered by the service provider. There is usage of network-based products and services. There are: bearer-based services (e.g. voice, SMS, MMS) and value added service, delivered over the bearer services (e.g. content delivered over SMS).

The service delivery infrastructure includes a set of hardware and software resources having configurations and underlying communication links. An example of a delivery network is a set of service centre and gateway platforms connected in a way to support messaging services over multiple bearers. “Service demand” is a quantified level of service that subscribers intend on consuming (e.g. SMS demand is 10 million messages a day). “Demand forecast” is the prediction, projection or estimation of expected demand over a specified future time period.

The framework automatically collects service usage data and service delivery infrastructure utilisation data. It automatically analyses this data, and then acts in an automatic feedback loop to optimise the network. As part of the analysis phase, the framework performs subscriber segmentation, which is a process of identifying distinct groups of subscribers with common service usage behavioural characteristics. Behavioural-based segmentation is important; therefore the segment definitions could include segments such as “Trend Followers”, “Intensive Users”, “Low Users”, and “Irregular browsers”. The subscriber segmentation provides a set of segmentation models representing behavioural characteristics of subscribers; and the framework derives service predictive models from a combination of segmentation models and other collected data concerning the network resources. The service predictive models are used to generate predictions and on this basis the framework automatically optimizes messaging infrastructure to for example introduce new services. The predictive aspect of the analysis is very important—allowing automatic pre-emptive network modification.

The segmentation models represent service usage patterns, specific to each subscriber segment. Service demand levels are determined relying on segment-specific service usage patterns. Forecasting techniques are used to produce differentiated service demand models (to reflect specific characteristics of individual subscriber segments). Service demand models are an example of service models.

Service predictive models are developed and optimised by correlating the service demand levels (produced as a result of subscriber analysis) and collected data concerning service delivery infrastructure utilisation. Service delivery infrastructure is optimised based on the models, produced for respective services, which optimisations in the main are in real-time but depending on the service optimisation can also be in near real time or performed over a longer period. The automated operation of the framework effectively results in automated understanding of subscriber preferences and behaviour to dynamically maintain a service delivery infrastructure accordingly.

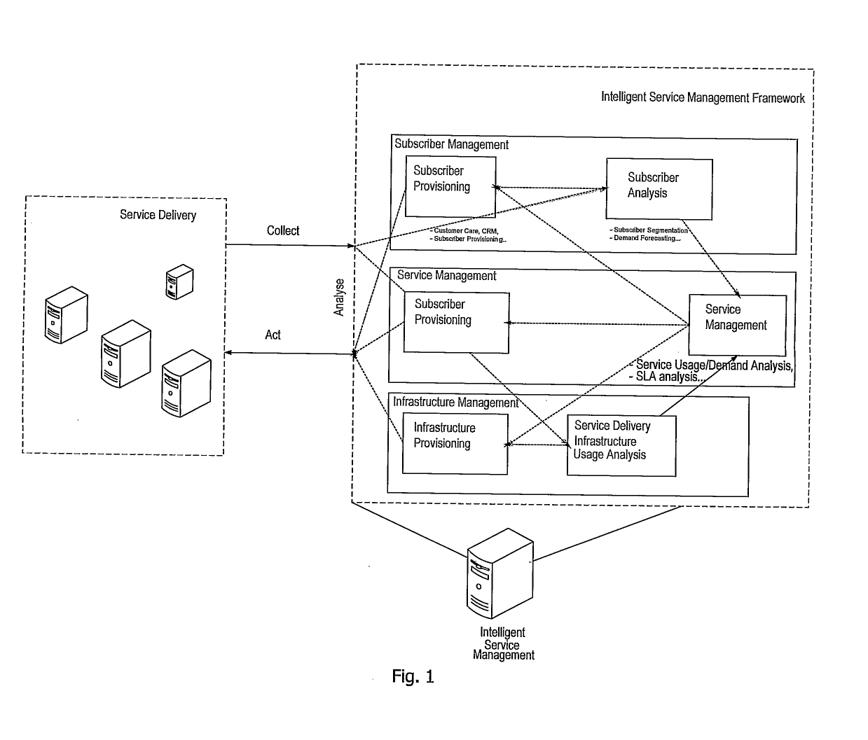

Referring to FIG. 1 the framework is shown interacting with a service delivery infrastructure to collect data and to act upon analysis to dynamically modify the infrastructure. The framework comprises, at a high level, functions for subscriber management, service management, and infrastructure management, all feeding into the dynamic actions to modify the infrastructure.

Usage information is collected by the intelligent framework components to create a complete profile of the subscribers. The framework analyses subscribers and builds the segmentation models, based on which a set of behavioural characteristics specific to various subscriber segments are created. Those characteristics provide an historical view of the behaviour of subscribers and are used to generate a set of predictive models. Alongside the subscriber-centric view, service platform utilisation information is aggregated by the framework to model how the service delivery infrastructure network elements perform.

The acting phase allows definition/deployment/adjustment of those services across the network in the most efficient way (which depending on the service adjustment can be in real-time), so that available platform resources are used optimally.

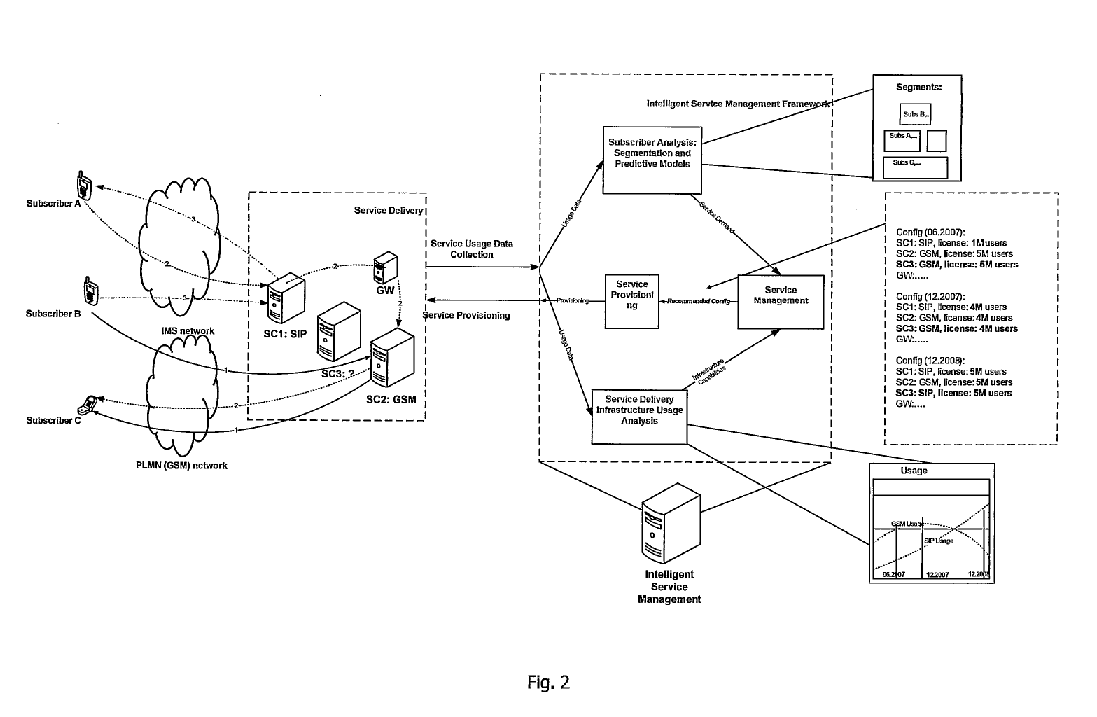

FIG. 2 shows an interaction of the intelligent framework components with service delivery infrastructure components. Also, it illustrates modules of the framework, namely subscriber analysis, service delivery infrastructure usage analysis, service management, and service provisioning modules. These interact with each other to provide the analysis and acting means based on collected data. Consider a service delivery infrastructure, consisting of a number of platforms, offering a messaging service over various networks. The framework is of benefit for optimising service delivery infrastructure to meet dynamic service demand even for established messaging services such as SMS where subscribers have access to a GSM network, an IMS network, or both networks.

For data collection, the framework interacts with the service delivery network to collect real-time transactional data, such as call detail record (CDR) streams, and monitoring information, such as performance objects. The real-time data collection and analysis (as opposed to the traditional data warehousing type of off-line post-processing, producing results in weeks/months time) supplies other analytical modules of the framework with up-to-date information.

Subscriber segmentation is an important aspect. In the example of FIG. 2 there are three subscribers: Subscriber A uses the service in a limited manner, however he is classified as being in the segment labelled “Trend Followers” (i.e. he sends 1 message over the IMS network—flow “2”, and receives 1 message over the same network—flow “3”); Subscriber B makes intensive use of the service over any available network at a given moment, and is classified as being in the segment labelled “Intensive Users” (flows “1” and “3”); User C is a low end user (just receives 2 messages over the GSM network—flows “1” and “2”)—is classified as being in the segment labelled “Low Users”. Once segmentation has been performed the predictive models are built to predict behaviour of the groups of subscribers. This allows the service provider to direct marketing activities and to predict demand in order to introduce new services in a controlled manner without disrupting established services. The predictive models predict service demand and their trends and the impact on the existing network elements (including their level of utilisation versus capacity). This enables efficient configuration of the network elements. For the depicted example: Subscriber B, belonging to the top segment of intensive and valuable service users, given his usage profile, if offered a proper level of access to the IMS network, is likely to continue increasing his use of that network in preference to the GSM network. Hence, subscribers in the same segment are likely to switch to the IMS network, whereby the service demand for the GSM network is likely to decline.

The subscriber analysis module provides real time information based on the service usage data, collected from the service delivery network components (further details on service usage data analysis are provided below).

In one example, automatic analysis of the service demand carried in the GSM and IMS networks allows evaluation of the level of utilisation of the service centres (SC1, SC2, and SC3) and the gateway (GW). Following the trend lines and looking at the sizing points at June 2007 (06.2007), end of 2007 (12.2007) and end of 2008 (12.2008) the required capacity for each type of service is determined (“Service Delivery Infrastructure Usage Analysis” component in FIG. 2).

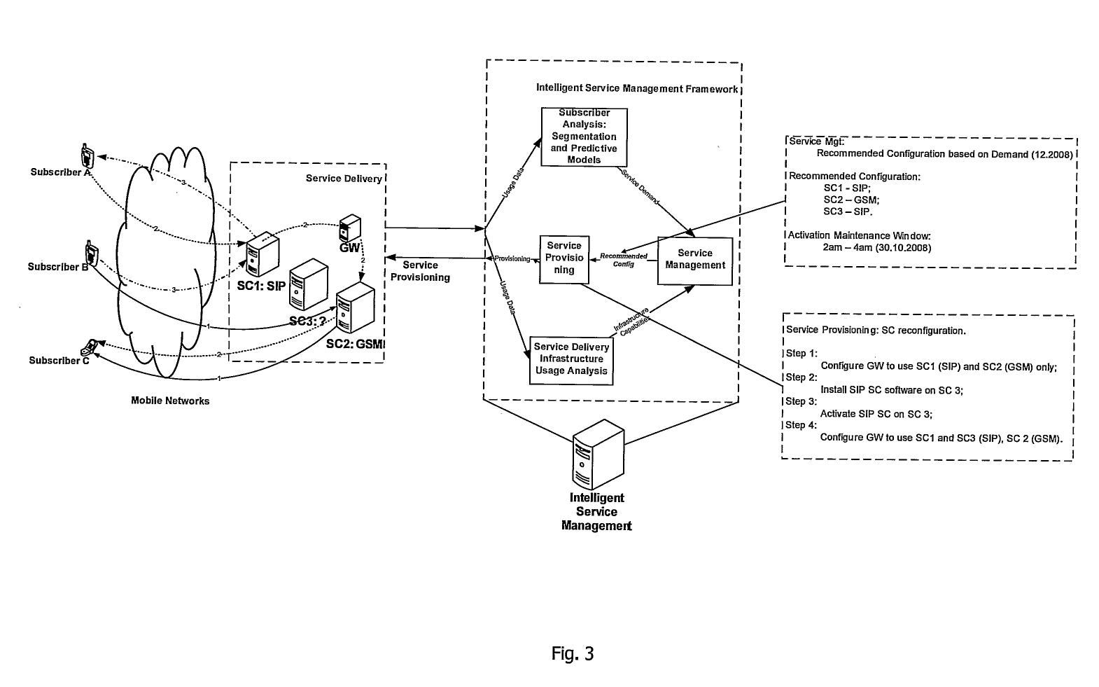

Referring to FIG. 3, automatic configuration of a network is shown, as an example of the “act” framework phase. For example, given the expected demand it is beneficial to keep SC3 as a GSM enabled service centre until that point in time when the GSM demand has declined sufficiently, and the demand for service access over the IMS network has increased to a certain critical mass. At a calculated point in time re-configuration of the SC3 to act as a SIP enabled platform (to interface with the IMS network) is performed (whereby the GW component is also reconfigured accordingly). In this example, all SCs are considered to be a set of hardware servers (e.g. blade based architecture) with a common architecture, running on a common OS/layered software stack (which is best practice among leading software vendors). Therefore, such a re-configuration action consists of activating SC application software (in the given example—SIP enabled SC software is activated on the SC3 platform), the GW connectivity (network end points) parameters are set up to point at SC1 and SC3 as SIP SCs, and SC2—as a GSM SC. Using the service usage daily pattern information the maintenance window (i.e. a time interval when the service demand is low) is determined. During this time interval the GW configuration is temporarily adjusted to utilise SC1 and SC2 only; the SIP SC software packages are activated (installed, if needed, and activated, using the service provisioning commands/primitives, supported by the SC platform/software and ‘known’ to the service provisioning module); and, when completed, the GW configuration is adjusted again to utilise all three SCs as mentioned above.

Thus, dynamic transformation of particular network nodes is achieved, whilst maintaining seamless service continuity for subscribers.

In-line with the other flexible service management considerations, the framework allows control of the effective network capacity dynamically allocated to the delivery network components, allowing optimisation of delivery of the service to the required degree (in terms of capacity).

The framework allows flexible licensing management and so is particularly advantageous for license agreements between operators and equipment suppliers, which are typically based on the maximum hardware capacity of the network elements, or estimated required capacity, or number of active subscribers. The framework performs adjustment of network element control parameters associated with licenses. Examples of control parameters are number of message delivery attempts per time period and number of active subscribers.

Considering the example with the SIP and GSM service centres above, the capacity is dynamically managed based on the actual monitored and predicted usage patterns. In the example above the subscriber analysis module provides the actual number of active subscribers, making use of the service over SIP versus GSM. The anticipated number of active subscribers (based on the predictive behavioural models) could be used to manage agreements between the operator and mobile virtual network operators (MVNOs), virtual network operators (VNOs), or value added service (VAS) providers or the service delivery infrastructure equipment/component vendors in a real-time manner.

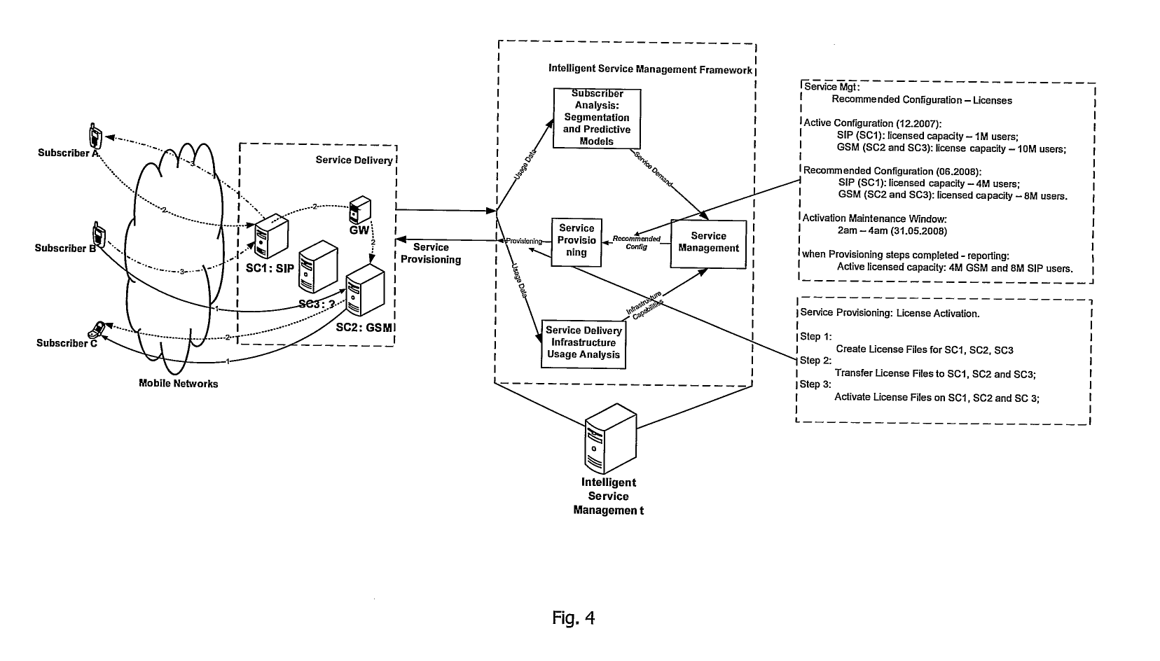

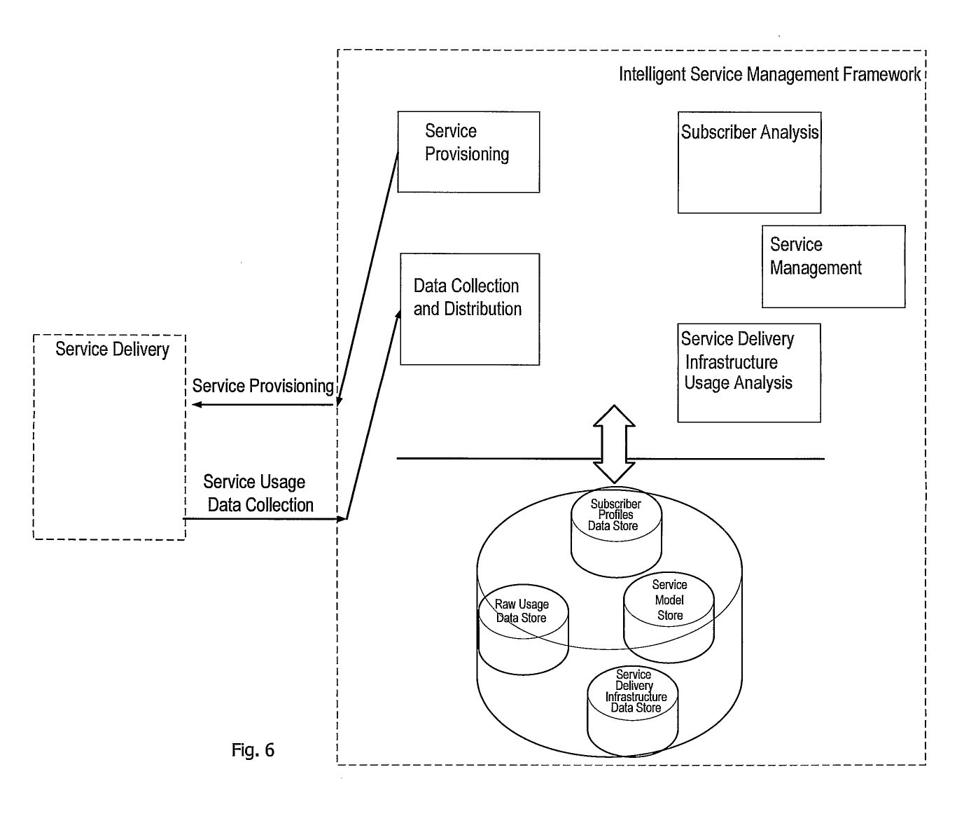

In FIG. 3, a license file and associated parameters, used by the SC applications, are provisioned to capture the required numbers. The provisioning process could be either set up to run in a fully automated way or to allow an operator to confirm the intention to extend the license configuration (given the commercial impact). The actual set of provisioning methods (and the logic to apply and orchestrate those on multiple delivery infrastructure components) is performed by the service provisioning module (based on the service models maintained in the respective data store—ref to FIG. 6). In any case, the information about the actual active licensed volumes is made available for financial accounting. FIG. 4 depicts this service management scenario. Dynamic control of licensing may be particularly advantageous in the scenario where an operator is hosting one or more mobile virtual network operators or virtual network operators, particularly in a flat fee billing scenario where the MVNO/VNO pays the operator based on the number of active subscribers.

It is important to note that similar to provisioning service-related attributes of the service delivery infrastructure components, the subscriber-related attributes are equally provisionable. Direct subscriber provisioning is performed in a comparable intelligent manner.

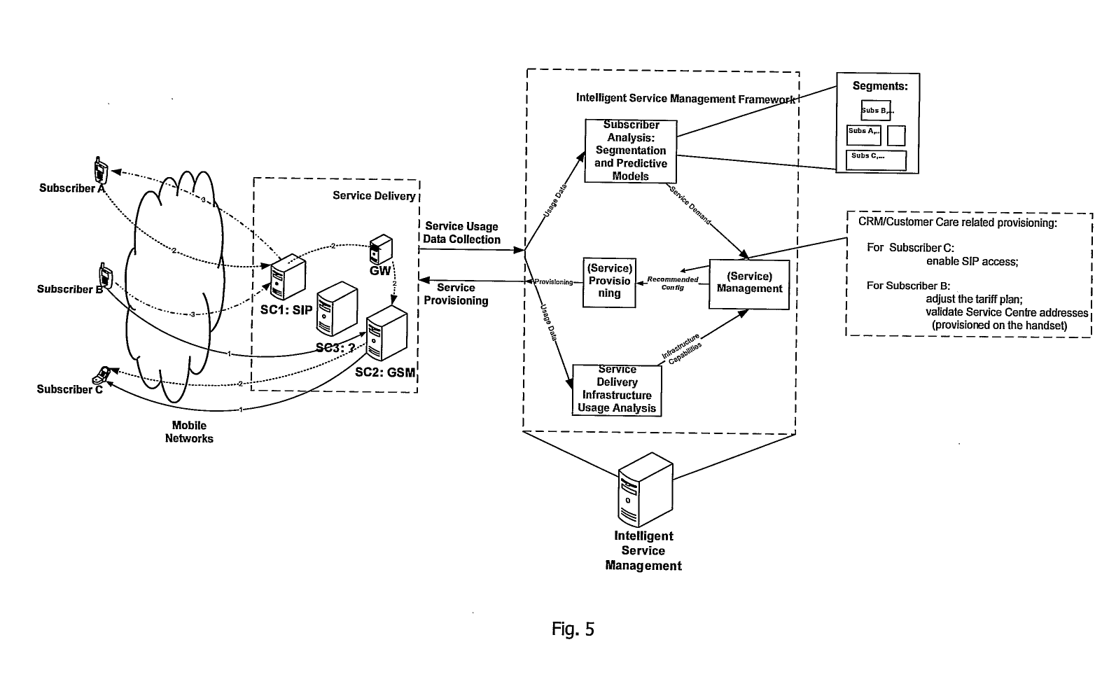

Referring to FIG. 5, attributes like tariff plan, SC address or type of services subscribed for by the subscribers can be provisioned towards the infrastructure components (and potentially, down to pushing information towards actual handsets using OTA mechanisms).

FIG. 6 illustrates the databases associated with the main modules of the intelligent service management framework.

A set of databases (the “subscriber profiles data store”, “service delivery infrastructure data store”, “raw usage data store” and “service model store” in FIG. 6) capturing relevant models are regularly updated with the analysis results of the usage information. The “data collection and distribution” module is a set of data adapters, capable of initial processing of the service usage data.

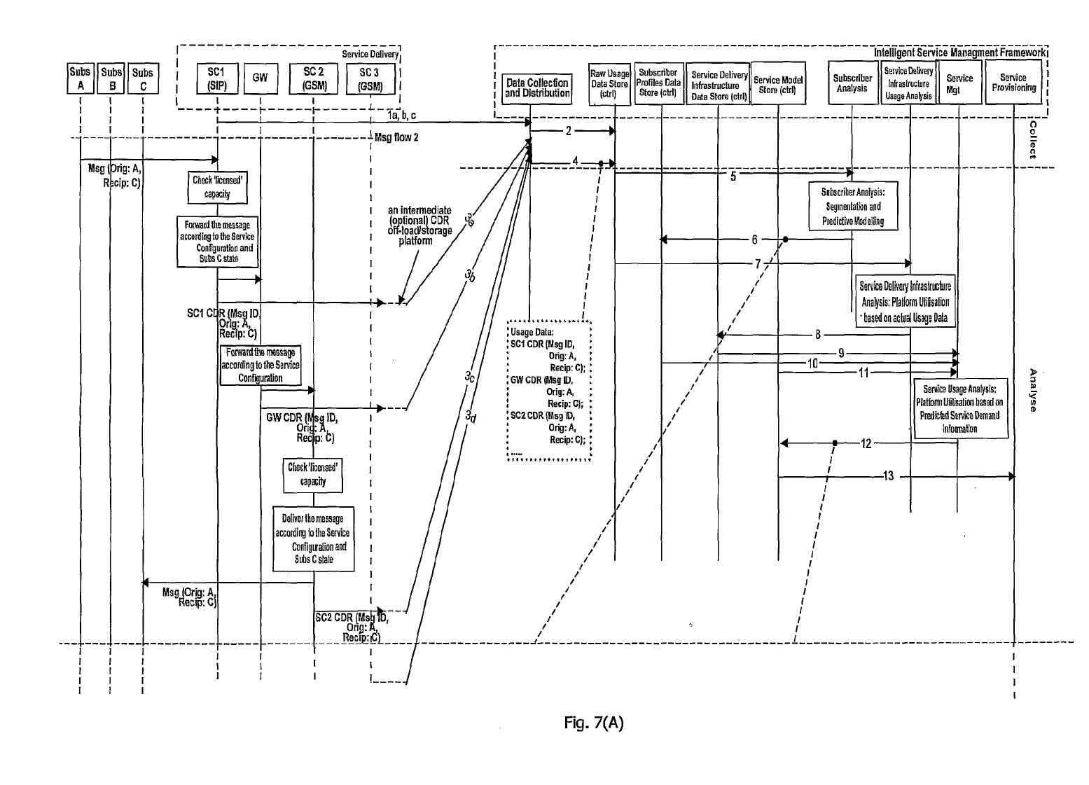

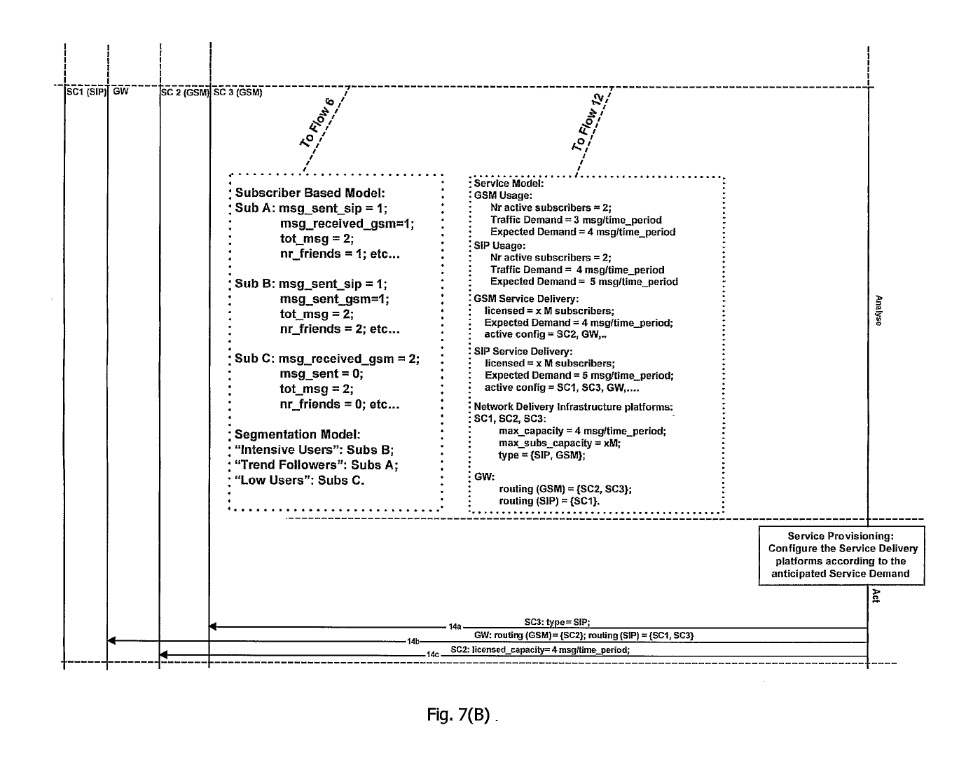

FIG. 7 represents a high level (simplified) call flow between the service delivery infrastructure components and the intelligent service management framework, and in particular depicts intelligent service provisioning based on both subscriber analysis and service delivery infrastructure usage analysis. The flow consists of three main stages: “collect”, “analyse” and “act”. The stages reflect the core principle of the intelligent service management framework: “collect” the service usage data, “analyse” it (from the subscriber analysis, service delivery infrastructure analysis and service analysis perspectives) and “act” upon analysis results to dynamically modify the network.

Service usage data collection, sanity checks and data assurance type of activities are performed as part of the “collect” phase: flows 1 (1a, 1b, 1c), and 3 (3a, 3b, 3c and 3d) reflect the actual data collection process (whereby either a pull or push or streaming mechanism could be used to transfer the usage data to the framework platform (the push mechanism is shown in the example). CDRs are used for information about individual transactions in the depicted example (flows 3a, 3b, 3c and 3d). Note the example message flow labelled “Msg Flow 2” in FIG. 7 corresponds to Message Flow 2 in FIG. 2, between originator Subscriber A and recipient Subscriber C, via SC1, GW and SC2. All the information below the dotted line to the left of “Msg flow 2”, starting from flow Msg(Orig: A, Recip:C) up to SC2 CDR (Msg ID, Orig: A, Recip:C) is associated with “Msg flow 2”. Either statistical data files or SNMP performance objects provide information about platform utilisation (flows 1a, 1b and 1c). Raw usage data is written to the raw usage data store without any significant transformation (flows 2 and 4).

The “analysis” phase consists of a number of stages. First of all, the transaction level data (flow 5) is processed and aggregated to the subscriber level (block “subscriber analysis: Segmentation and Predictive Modelling”), whereby a set of basic behavioural and derived trends are calculated for each subscriber (flow 6). Subscriber segmentation is performed within the same step: subscriber segments are identified based on a set of behavioural rules (block “subscriber analysis” and flow 6). A set of segment-level trends which represent behavioural characteristics of all subscribers, belonging to a segment, are calculated as well. These aggregated segment-level trends (basic and derived, which hold results of predictive models) form input for further service demand analysis.

A similar activity is performed with regard to the service delivery infrastructure analysis—the raw usage data is analysed, whereby the platform utilisation data, is combined with transaction information to get a complete picture as needed, (flow 7). A set of trends is produced for individual service centres, i.e. components of the service delivery infrastructure (flow 8).

The final analysis step is correlation of the following three elements (provided by previous stages):
Service demand levels (actual and forecast): service demand values, produced for individual segments (reflecting their specific characteristics) are aggregated to the total service demand levels (those service demand levels are captured in basic and derived trends—flow 10);
The service predictive model (i.e. how individual services are defined over the delivery infrastructure components—flow 9);
Service delivery infrastructure utilisation information (platform level trends, reflecting the levels of utilisation—flow 11).

(Refer to the intelligent service management framework modules in FIG. 2 or FIG. 3).

The service predictive model is adjusted based on the analysis results, whereby a recommended set of characteristics specific to network elements is determined and activated (flow 12).

In the “act” phase the recommended service configuration (flow 13) is propagated to the actual service delivery infrastructure components (flows 14a, 14b and 14c).

In more detail, the following explains how the network is dynamically modified because of the actions of the framework. As described above with reference to FIG. 3, given the expected demand it is beneficial to keep SC3 as a GSM-enabled service centre until that point in time when the GSM demand has declined sufficiently, and the demand for service access over the IMS network has increased to a certain critical mass. The framework automatically determines a point in time for re-configuration of the SC3 to act as a SIP-enabled platform to interface with the IMS network. It implements this re-configuration and the GW component is also reconfigured accordingly. In this example, all SCs are considered to be a set of hardware servers (e.g. blade-based architecture) with a common architecture, running on a common OS/layered software stack (which is best practice among leading software vendors).

Flow 14a shows a re-configuration action consisting of activating SC application software. In the given example—SIP enabled SC software is activated on the SC3 platform.

As shown in flow 14b, the GW connectivity (network end point) parameters are set up to point at SC1 and SC3 as SIP SCs, and SC2—as a GSM SC. Using the service usage daily pattern information the maintenance window (i.e. a time interval when the service demand is low) is determined. During this time interval the GW configuration is temporarily adjusted to utilise SC1 and SC2 only; the SIP SC software packages are activated (installed, if needed, and activated, using the service provisioning commands/primitives, supported by the SC platform/software and ‘known’ to the service provisioning module); and, when completed, the GW configuration is adjusted again to utilise all three SCs as mentioned above.

Flow 14c shows that, due to service demand, the framework acts to provide an increase in the capacity of SC2 to cater for higher message throughput.

Architecture of the Framework

Heretofore the challenge of dynamically managing a service delivery infrastructure has not been addressed in a highly automated manner apparently because of the perception that there would be an excessive amount of processing required and indeed complexity in development and maintenance of the system. The invention provides an architecture for the framework and particularly the analysis means which achieves automatic feedback and action without excessive overhead.

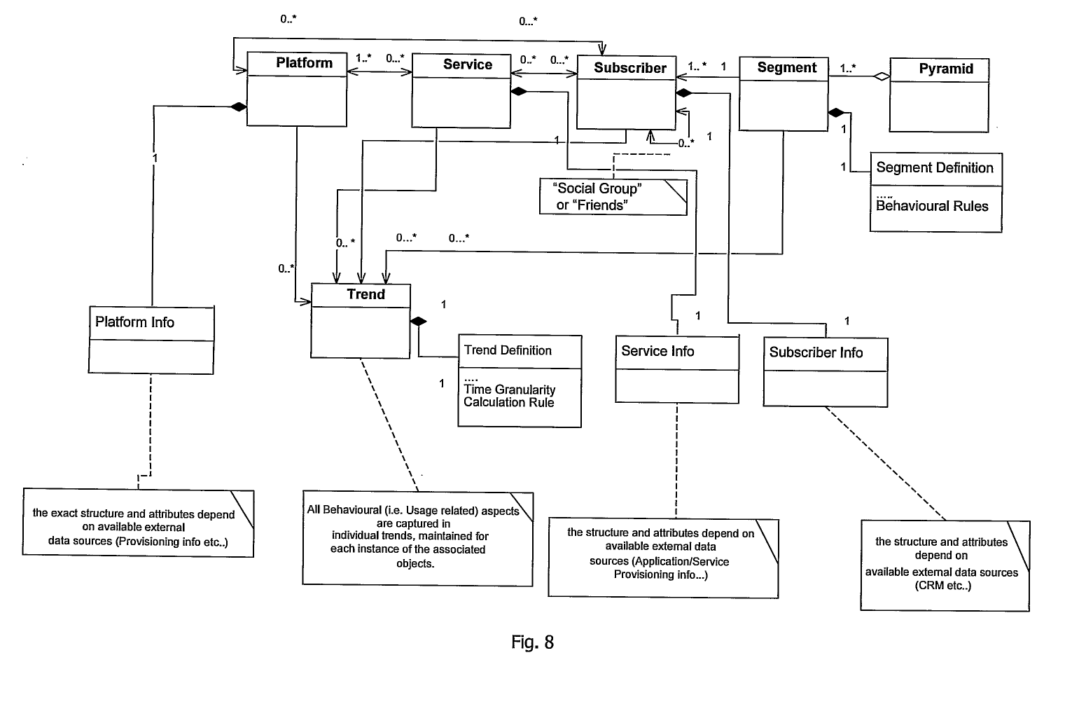

Referring to FIG. 8, this illustrates a high level data model of the intelligent service management framework. In the above examples the models used by the framework include the data objects below.

Subscriber: The subscriber represents the entity that uses services, i.e. has some form of subscription. The subscriber can be either a mobile user or an application. It will typically be uniquely represented by an ID (for example, MSISDN, short code, potentially an IMSI or a set of IP addresses). Additional objects (the “Subscriber Info” object in the overview), related to Subscriber, could be added if relevant data is available (e.g. “Equipment” Object, phone, or PDA, “Subscriber Services”, “Tariff' to represent the tariff associated with the subscription type and detail the charges which are applied for particular services, “Promotion” to represent activities such as campaign or special offer or bundles applied against a user).

The “Subscriber Info” object has interfaces to external systems such as CRM, customer care, or provisioning modules.

Service: the object represents various services offered by the service provider (in case of Value Added Service—potentially over multiple bearers). Usage of a service by a subscriber, i.e. the fact that a subscriber consumes various services, is represented by the association between the objects. In practice, the link between the Service and Subscriber objects is used to analyse the Service Demand. Similarly, a “Service Info” object holds available Service details (whereby interfacing with the Service Provisioning module is implemented).

Platform (network element): the object represents a network element of the service delivery infrastructure (e.g. a service centre or a gateway platform). The fact that services are delivered over a multiple set of platforms is represented by the relationship between the objects. Similarly to the Service—Subscriber objects relationship, the link between the Service and Platform objects is used to determine the level of utilisation of the service delivery infrastructure components and determine optimal service configurations over the set of platforms.

Trend: To represent the dynamic aspects of various elements the Trend object is executed to track behaviour of associated objects, for example “subscriber”, “service”, “platform” and “segment” objects. Trends, or behavioural variables, could be basic and derived (to keep the objects overview diagram simple the related data objects are left out). Basic trends represent information, directly related to the usage such as “Number of messages received over a particular bearer”, “Total charged amount” per subscriber per time period or per service per time period. Various granularity levels are supported to efficiently aggregate and maintain data, e.g. hourly trends, daily trends, weekly trends. Derived trends are used to hold results of various analytical models that are typically built using a number of basic trends. Examples are: predictive trends “Growth decile score”, “Browsing propensity”, “IMS usage propensity” or “Churn Decile score” per subscriber or per segment, where each of those trends is calculated using a number of basic trends aggregated for various time periods, “Average Revenue” or “IMS usage level” per segment. Derived trends are primarily used to determine the anticipated level of the service demand (which is one of the main input parameters for service management).

In case of platform related trends, levels of resource utilisation (hardware resources, e.g. CPU or network bandwidth, or software buffers and available contexts) are monitored using the Trend objects. Those types of trends are used as input, reflecting utilisation of the service delivery infrastructure components, for the service management.

Segment: A subscriber is associated with a segment based on various behavioural characteristics, i.e. the rules defined based on Subscriber level trends. A subscriber can change segment over time although the segments themselves are relatively static.

Pyramid: an aggregation of all defined segments forms a full customer pyramid.

The combination of objects is utilized by the framework to achieve an automatic feedback loop. The following describes this in more detail.

The following objects are identified in FIG. 8. Note that in order to keep the example simple the values provided are low and are for the purposes of indicating the dynamics of analysis, with real life examples dealing with much larger values. Similarly, specific trends and the number of configuration items, analysed in the example, are limited to a few items only to simplify the explanation.

The Subscriber Profiles and related trend analysis (created directly based on collected CDRs: SC1 CDR (Msg ID, Orig: A, Recip: C), GW CDR (Msg ID, Orig: A, Recip: C), SC2 CDR (Msg ID, Orig: A, Recip: C) and similar CDRs, generated for other call flows, shown in FIG. 2):

Subscriber Object: “Subs A”;

Related Trend objects:

Trend Object: msg_sent_sip;

Value = 1;

Trend Object: msg_received_sip;

Value = 1;

Trend Object: tot_msg;

Value = 2;

Trend Object: nr_friends = 1;

Subscriber Object: “Subs B”;

Related Trend objects:

Trend Object: msg_sent_sip;

Value = 1;

Trend Object: msg_sent_gsm;

Value = 1;

Trend Object: tot_msg;

Value = 2;

Trend Object: nr_friends = 2;

Subscriber Object: “Subs C”;

Related Trend objects:

Trend Object: msg_sent;

Value = 0;

Trend Object: msg_received_gsm;

Value = 2;

Trend Object: tot_msg;

Value = 2;

Trend Object: nr_friends = 1;

The segmentation model and an overview of subscribers allocated in segments is represented by the following objects:

Segment Object: “Intensive Users”;

Related Subscriber objects:

Subscriber Object: “Subs B”;

Segment Object: “Trend Followers”;

Related Subscriber objects:

Subscriber Object: “Subs A”;

Segment Object: “Low Users”;

Related Subscriber objects:

Subscriber Object: “Subs C”;

Looking at the service predictive models at the segment level, the following trends are used to capture the model results (“Expected Demand SIP” and “Expected Demand GSM”—for the predicted values of the service demand levels of respective services):

Segment Object: “Intensive Users”;

Related Trend objects:

Trend Object: “Nr active subscribers GSM”;

Value = 1;

Trend Object: “Traffic Demand GSM”;

Value = 1 msg/time_period;

Trend Object: “Expected Demand GSM”;

Value = 2 msg/time_period;

Trend Object: “Nr active subscribers SIP”;

Value = 1;

Trend Object: “Traffic Demand SIP”;

Value = 1 msg/time_period;

Trend Object: “Expected Demand SIP”;

Value = 1 msg/time_period;

Segment Object: “Trend Followers”;

Related Trend objects:

Trend Object: “Nr active subscribers GSM”;

Value = 0;

Trend Object: “Traffic Demand GSM”;

Value = 0 msg/time_period;

Trend Object: “Expected Demand GSM”;

Value = 1 msg/time_period; //note: this is to

indicate the fact Subs A is provisioned on the GSM network
as well and might start using it.

Trend Object: “Nr active subscribers SIP”;

Value = 1;

Trend Object: “Traffic Demand SIP”;

Value = 1 msg/time_period;

Trend Object: “Expected Demand SIP”;

Value = 3 msg/time_period;

Segment Object: “Low Users”;

Related Trend objects:

Trend Object: “Nr active subscribers GSM”;

Value = 1;

Trend Object: “Traffic Demand GSM”;

Value = 2 msg/time_period;

Trend Object: “Expected Demand GSM”;

Value = 1 msg/time_period;

Trend Object: “Nr active subscribers SIP”;

Value = 0;

Trend Object: “Traffic Demand SIP”;

Value = 0 msg/time_period;

Trend Object: “Expected Demand SIP”;

Value = 0 msg/time_period;

Clearly, given a different behaviour of subscribers in different segments, the predictive models produce different results for individual segments (e.g. the trend followers are likely to have different dynamics of behaviour in the future than the intensive users, even if both segments have similar starting positions in terms of service utilisation levels).

Once the service level demands are understood (modelled) at a per segment level, proper prediction for the expected service demand level is done:

Service Object: “GSM”;

Related Trend objects:

Trend Object: “Nr active subscribers”;

Value = 2;

Trend Object: “Traffic Demand”;

Value = 3 msg/time_period;

Trend Object: “Expected Demand”;

Value = 4 msg/time_period;

Service Object: “SIP”;

Related Trend objects:

Trend Object: “Nr active subscribers”;

Value = 2;

Trend Object: “Traffic Demand”;

Value = 4 msg/time_period;

Trend Object: “Expected Demand”;

Value = 5 msg/time_period;

Consider the service delivery network components utilisation. The active service definition models and analysis of levels of utilisation of individual platforms, which rely on the performance metrics related trends, are as follows:

The initial Service delivery model definition:

Service Object: “SIP”;

Related “Service Info” objects:

Service Configuration Object: “active config”;

Value = “SC1, GW,..”

Related Trend objects:

Trend object: “licensed active subscribers”

Value = “xM subscribers” (// note: this is

controlled using the “Nr active subscribers” at the per
Segment level, as outlined in FIG. 2.).

Service Object: “GSM”;

Related “Service Info” objects:

Service Configuration Object: “active config”;

Value = “SC2 SC3, GW,..”

Related Trend objects:

Trend object: “licensed active subscribers”

Value = “xM subscribers”

The Service Delivery Infrastructure platforms characteristics:

Platform Object: “SC2”;

Trend object: “utilised_capacity”;

Value = “2 msg/time_period”

Trend object: “utilised_subs_capacity”;

Value = “3 users”

Platform Info objects:

Object: “type”;

Value = “GSM”;

Object: “max_capacity”;

Value = 4 msg/time_period;

Object: “max_subs_capacity”;

Value = “xM”;

Platform Object: “SC3”;

Trend object: “utilised_capacity”;

Value = “2 msg/time_period”

Trend object: “utilised_subs_capacity”;

Value = “2 users”

Platform Info objects:

Object: “type”;

Value = “GSM”;

Object: “max_capacity”;

Value = 4 msg/time_period;

Object: “max_subs_capacity”;

Value = “xM”;

Platform Object: “SC1”;

Trend object: “utilised_capacity”;

Value = “x msg/time_period”; (//note: the exact “x”

value is derived from other call flows, not elaborated on in this example.)

Trend object: “utilised_subs_capacity”;

Value = “2 users”

Platform Info objects:

Object: “type”;

Value = “SIP”;

Object: “max_capacity”;

Value = 4 msg/time_period;

Object: “max_subs_capacity”;

Value = “xM”;

Platform Object: GW:

Platform Info objects:

Object: “GSM routing”;

Value = “SC2, SC3”;

Object: “SIP routing”;

Value = “SC1;

(note:
for simplicity the capacity of the GW component itself is left out of the example.)

Referring to the predicted demand level for both GSM and SIP services, which are (as outlined above):

Service Object: “SIP”;

Trend Object: “Expected Demand”;

Value = 5 msg/time_period;

Service Object: “GSM”;

Trend Object: “Expected Demand”;

Value = 4 msg/time_period;

The framework automatically determines that there is not enough capacity, allocated to serve the predicted SIP service element demand according to the current service predictive model (i.e. the maximum capacity of SC1 is 4 msg/time_period versus the expected SIP service demand being 5 msg/time_period). It also determines that there is under-utilised GSM capacity (the expected GSM service demand is 4 msg/time_period versus both SC2 and SC3 having 4 msg/time_period as their maximum throughput capacity). The framework therefore adjusts the Service predictive model from:

Service Object: “SIP”;

Related “Service Info” objects;

Service Configuration Object: “active config”;

Value = “SC1, GW,..”

Service Object: “GSM”;

Related “Service Info” objects;

Service Configuration Object: “active config”;

Value = “SC2, SC3, GW,..”

Service Object: “SIP”;

Related “Service Info” objects;

Service Configuration Object: “active config”;

Value = “SC1, SC3, GW,..”

Service Object: “GSM”:

Related “Service Info” objects;

Service Configuration Object: “active config”;

Value = “SC2 GW,..”

As such the required increased SIP service demand is met by properly utilising available delivery components, i.e. SC3, being re-configured from a GSM type of service centre to SIP. Additionally, the capacity of SC2 is increased to be able to deal with the predicted service level demand.

The configuration of individual platforms is adjusted accordingly:

Platform Object: SC3:

Platform Info objects:

Object: “type”;

Value = “SIP”;

Platform Object: SC2;

Platform Info objects:

Object: “licensed_capacity”;

Value = “4 msg/time_period”;

Platform Object: GW;

Platform Info objects:

Object: “GSM routing”;

Value = “SC2”;

Object: “SIP routing”;

Value = “SC1, SC3”;

Thus, the actual model objects and their values are translated into the platform configuration commands and activated on all affected platforms (e.g. the SC type becoming “SIP” is translated into the SIP SC software packages activation commands, the configured licensed throughput capacity is adjusted using appropriate provisioning commands, the GW routing configuration results in a set of routing tables related commands.). Similar to this example, where the throughput capacity is managed relying on the expected demand levels, the number of active subscribers (and resources allocated to them on individual service delivery infrastructure platforms) is controlled. Also, the invention allows control of the number of active subscribers and the resources allocated.

In the above detailed example only a very limited number of subscribers is referred to, for clarity. However, in practice there would in general be- many more subscribers, as indicated for example in FIG. 2 in which millions of subscribers are referred to.

The following examples illustrate further the flexibility and extensive applicability of the framework.

Marketing Campaign Management Example

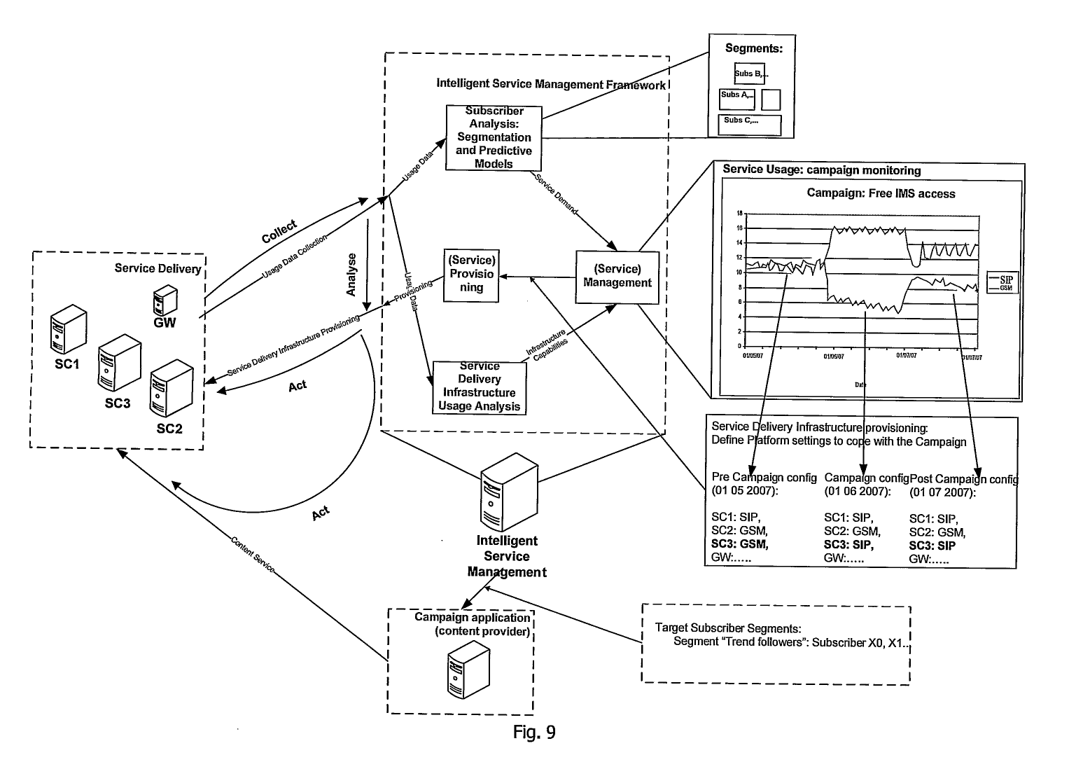

The same framework is used in the campaign management case (e.g. an advertising campaign). Refer to FIG. 9.

The ability to dynamically adjust the configuration of service delivery infrastructure to cope with campaigns (which depending on the service adjustment can be in real-time), is an important aspect of the framework. In the given example, if a marketing campaign (to stimulate the usage of the Messaging Service over IMS/SIP—e.g. a “free IMS access for the whole month of June” offer for a set of target subscribers, selected based by the Subscriber Analysis module) is run, the GW and SC configurations are adjusted in near “real-time” mode (based on the constantly monitored uptake level of the campaign). Similarly, during the post campaign monitoring mode, the new Service Delivery components are reconfigured to accommodate the needs.

Control service usage data collection is constantly performed to validate active configurations and allows demand forecast creation based on the actual levels of utilisation, thus allowing the subscriber, service infrastructure components utilisation, and service demand models at all levels to be constantly tuned.

Thus modelling service demand levels and service delivery infrastructure utilisation enables the identification, activation of and efficient running of specific marketing campaigns to optimize the service delivery infrastructure. This can include for example campaigns to encourage/enable better utilization during off-peak hours, or for example different pricing strategies to decrease usage (or increase revenue) during peak hours.

SLA Management Example

Another example serves to illustrate the dynamic aspect of configuration control.

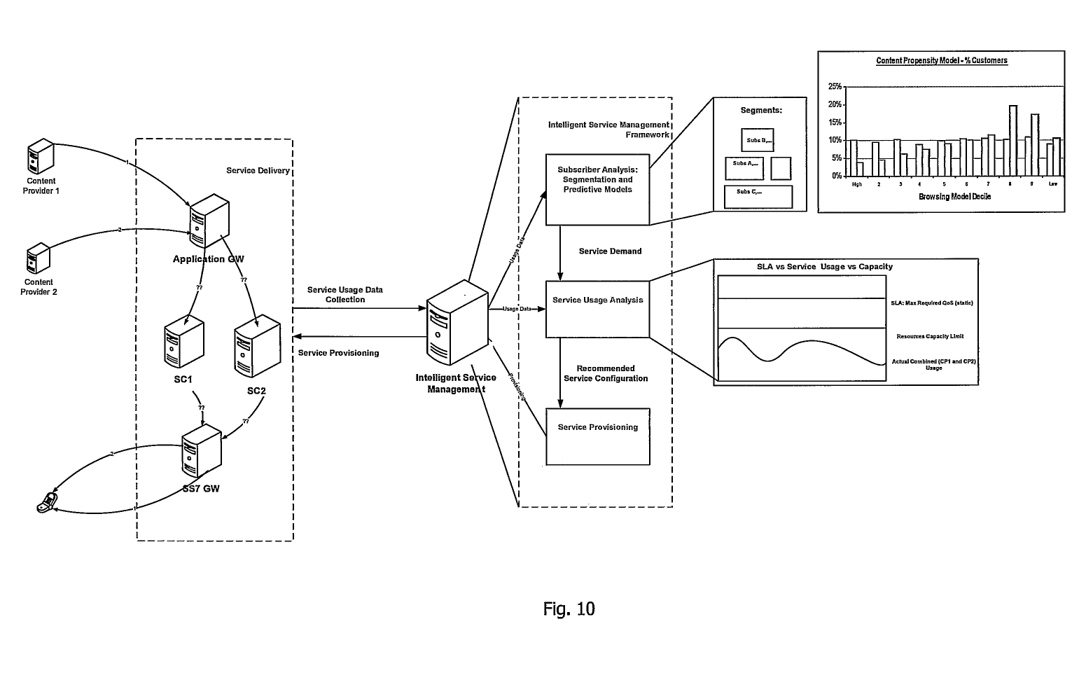

FIG. 10 shows a simplified scenario to control the service delivery infrastructure, in the context of value added services (VAS) management. Two content providers supply various types of content and have SLAs with the operator to guarantee a particular level of QoS. The task of the operator becomes to manage the available infrastructure in order that the SLAs can be met, and at the same time the available network platforms (resources) are utilised optimally.

If all agreed QoS levels are to be implemented on the delivery network in a static manner, the total level of required resources could be higher than the actual level of available network resources. However, understanding the actual level of utilisation, based on the monitored and modelled service demand (“content propensity model” as shown on the figure), the services can be dynamically provisioned over the available platforms utilising the resources (e.g. allocated in-flight capacity and content validity periods, application network connections and their bandwidth, dedicated to a particular content provider, routing resources between the application GW, Service Centres and SS7 Gateway).

The example illustrates how the invention facilitates the management of multiple services, delivered by a set of shared service delivery infrastructure components, (where multiple co-existing services can also be managed on a single shared platform or multiple shared platforms) which is a widely deployed approach for service delivery infrastructure setup. The “??” annotation in the flows from the application gateway to SC1 and SC2 and from SC1 and SC2 to the SS7 GW in FIG. 10 indicate that these flows can be of a variety of types, illustrating flexibility of the invention. For example, any of the services of the two service providers can have content routed through either or both of SC1 and SC2 in providing a service.

In the QoS context, individual service requests, originated by or destined to subscribers (or originated from subscriber to VASP or originated from VASP to subscriber), for subscribers belonging to the top segments, could be granted a higher QoS than to those from/to the subscribers from the low value segments (e.g. in case of a limited license capacity or bandwidth, SMS delivery attempts could be prioritised based on dynamically provisioned subscriber characteristics, such as the segment it belongs to).

Fair Use Charging Example

Another example serves to illustrate the dynamic aspect of configuration control, coupled with direct automatic customer care interaction with a particular subscriber.

A subscriber can subscribe to a particular flat fee tariff. Flat fee tariffs can be configured associated with subscriber segments. The framework is particularly adapted to configuration of flat fee tariffs as it provides a comprehensive view of subscriber behavioural and usage characteristics. This can be used to implement fair use policies which can be associated with particular subscriber segments. Thus if a subscriber exceeds usage beyond the flat fee tariff, automatic action can be taken by the operator such as re-prioritizing of that subscribers messages in delivery queues, or adjusting the bandwidth on the IP network for a particular subscriber based on usage. The system could generate a message such as an SMS to the subscriber indicating that the subscriber has exceeded the fair use policy applicable to them.

MMS Use Case Example

Another example serves to illustrate the dynamic aspect of configuration control, coupled with direct automatic customer care interaction with a particular subscriber.

If a subscriber has normally been a high MMS user and suddenly MMS use ceases, the framework is adapted to detect such a drop in usage. Automatic Action can be taken such as the system proactively generating an SMS to the subscriber indicating that customer care help is available if for example there are handset issues. Additionally, a work item for an customer care person to follow up on can be generated.

The framework dynamically combines collect, analyse, and act phases whereby the full service management cycle is performed in the main in a real-time manner (although depending on the nature of the “act” phase this phase can be in real time, near real time or over a longer period).

The framework advantageously is also very suitable as a means or input for network capacity planning, where for example subscriber segmentation and the behaviour of subscribers within a segment can be used for network capacity planning. Depending on the required capacity changes this can be a long term process.

In addition, the invention is applicable to service management of a single service on a dedicated platform, or to service management of one or multiple co-existing services on a single shared platform or multiple shared platforms.

The invention is not limited to the embodiments described herein but may be varied in construction and detail. For example, the models may be implemented other than as objects, for example, via functional programming. Also, the invention may be implemented with actions involving technology stacks other than GSM and IMS, such as CDMA or TDMA. Also, the invention may be implemented with technology stacks required to deliver content such as video streaming to mobile devices. Further, actions other than those described may be implemented by the framework. Also, although the description of the invention has focused on SMS-related services, it is equally applicable to MMS, IM, mobile browsing, and other related services or technologies.

1-34. (canceled)

35. A service management framework for operation in a communication network having a service delivery infrastructure with network elements providing services to subscribers, the service management framework comprising :
collecting means for collecting service delivery data from the network;
analysis means for analysing said data by performing the steps of:
performing, using subscriber profiles, subscriber segmentation to generate segmentation models representing behavioural characteristics of subscribers,
deriving service predictive models from said segmentation models and collected network infrastructure data, said service predictive models correlating service demand levels and network infrastructure utilisation, and
determining in response to said predictive models actions to dynamically and pre-emptively modify the service delivery infrastructure of the network to optimise service delivery; and
acting means adapted to perform said actions.

36. The framework as claimed in claim 35, wherein the analysis means is adapted to generate at least one service predictive model for each network element, group of network elements, or subscriber segment or subscriber segments.

37. The framework as claimed in claim 35, wherein the analysis means or the collecting means is adapted to execute a set of data adapters for initial processing of collected data.

38. The framework as claimed in claim 35, wherein the, analysis means is adapted to use agreed quality of service requirements when determining an action to be implemented which may affect quality of service.

39. The framework as claimed in claim 35, wherein the, analysis means is adapted to use agreed quality of service requirements when determining an action to be implemented which may affect quality of service; and wherein the analysis means is adapted to determine an action to be implemented which affects quality of service for a subscriber segment and not other subscriber segments, the determined actions being selected from one or more of re-prioritizing a subscriber's messages in delivery queues, adjusting bandwidth for a subscriber, message re-direction to particular service centres, or re-allocation of hardware resources across multiple services.

40. The framework as claimed in claim 35, wherein said service predictive models track network infrastructure utilisation parameters including current number of active subscribers, traffic demand, projected number of active subscribers, and expected demand.

41. The framework as clamed in claim 35, wherein the analysis means comprises means for generating network element models defining characteristics of network element configurations.

42. The framework as claimed in claim 35, wherein the analysis means comprises means for generating network element models defining characteristics of network element configurations; and wherein the analysis means comprises means for performing analysis of relationships between said segmentation, service predictive, and network element models.

43. The framework as claimed in claim 35, wherein the analysis means comprises means for generating network element models defining characteristics of network element configurations; and wherein the analysis means comprises means for managing subscriber objects each including at least a subscriber identifier, and service objects each defining a service, and for managing associations between these objects to develop the models.

44. The framework as claimed in claim 35, wherein the analysis means comprises means for generating network element models defining characteristics of network element configurations; and wherein the analysis means is adapted to manage subscriber segment objects, each defining a subscriber behaviour segment, and to manage network element objects each defining a network element of the service delivery infrastructure and its associations with service objects.

45. The framework as claimed in claim 35, wherein the analysis means comprises means for generating network element models defining characteristics of network element configurations; and wherein the analysis means is also adapted to manage trend objects, each trend object representing dynamic aspects of at least one parameter and being executed to track behaviour of a subscriber object, a service object, a network element object, and a segment object.

46. The framework as claimed in claim 35, wherein the analysis means comprises means for generating network element models defining characteristics of network element configurations; and wherein the analysis means is also adapted to manage trend objects, each trend object representing dynamic aspects of at least one parameter and being executed to track behaviour of a subscriber object, a service object, a network element object, and a segment object; and wherein at least one trend object tracks a basic trend and at least one trend object tracks a derived trend including service demand which is derived from at least one basic trend object.

47. The framework as claimed in claim 35, wherein the analysis means comprises means for generating network element models defining characteristics of network element configurations; and wherein the analysis means is also adapted to manage trend objects, each trend object representing dynamic aspects of at least one parameter and being executed to track behaviour of a subscriber object, a service object, a network element object, and a segment object; and wherein at least one trend object tracks a basic trend and at least one trend object tracks a derived trend including service demand which is derived from at least one basic trend object; and wherein each segmentation model comprises a segment object and related subscriber objects and the subscriber objects are related to trend objects representing subscriber behavioural characteristics.

48. The framework as claimed in claim 35, wherein the analysis means comprises means for generating network element models defining characteristics of network element configurations; and wherein the analysis means is also adapted to manage trend objects, each trend object representing dynamic aspects of at least one parameter and being executed to track behaviour of a subscriber object, a service object, a network element object, and a segment object; and wherein a service predictive model comprises a segment object and related trend objects.

49. The framework as clamed in claim 35, wherein the analysis means and the acting means comprise means for determining if a subscriber exceeds fair usage beyond a flat fee tariff, and for performing an automatic action of re-prioritizing that subscriber's messages in delivery queues, or adjusting bandwidth for the subscriber.

50. The framework as claimed in claim 35, wherein the analysis means and the acting means comprise means for performing automatic subscriber re-provisioning including changing a subscriber's service centre address.

51. The framework as claimed in claim 35, wherein the analysis means and the acting means comprise means for notifying a subscriber of an action which has been performed or needs to be performed by the subscriber.

52. The framework as claimed in claim 35, wherein the analysis means and the acting means comprise means for performing automatic pushing of information to subscriber devices.

53. The framework as claimed in claim 35, wherein the analysis means and the acting means comprise means for performing automatic pushing of information to subscriber devices; and wherein the analysis means and the acting means comprise means for performing automatic pushing of information for Over-the-Air device re-configuration.

54. The framework as claimed in claim 35, wherein the analysis means and the acting means comprise means for performing automatic re-configuration of a network element.

55. The framework as claimed in claim 35, wherein the analysis means and the acting means comprise means for performing automatic re-configuration of a network element to operate with a different technology stack, such as transfer from GSM to IMS (SIP enabled).

56. The framework as claimed in claim 35, wherein the analysis means and the acting means comprise means for automatically adjusting operation of a network element for service delivery optimisation.

57. The framework as claimed in claim 35, wherein the analysis means and the acting means comprise means for automatically adjusting operation of a network element for service delivery optimisation; and wherein the analysis means and the acting means comprise means for automatically adjusting network control parameters including message delivery attempts per time period or number of active subscribers.

58. The framework as claimed in claim 35, wherein the analysis means and the acting means comprise means for automatically adjusting operation of a network element for service delivery optimisation; and wherein the analysis means and the acting means comprise means for automatically adjusting network control parameters including message delivery attempts per time period or number of active subscribers; and wherein the control parameters are associated with a license for a network element or group of network elements.

59. The framework as claimed in claim 35, wherein the analysis means and the acting means comprise means for performing automatic re-configuration of a network element; and wherein the analysis means and the acting means comprise means for performing automatic re-configuration by activating software resident on network element hardware servers to achieve intelligent service provisioning.

60. The framework as claimed in claim 35, wherein the analysis means and the acting means comprise means for performing automatic re-configuration of a network element; and wherein the analysis means and the acting means comprise means for performing automatic re-configuration by installing software on network element hardware servers to achieve intelligent service provisioning.

61. The framework as claimed claim 35, wherein the analysis means and the acting means comprise means for performing automatic activation of hardware servers to augment processing capacity of certain network elements.

62. The framework as claimed in claim 35, wherein the analysis means and the acting means comprise means for performing re-configuration of a server to allow or prioritise delivery of content from or to a content provider or a subscriber.

63. The framework as claimed in claim 35, wherein the analysis means and the acting means comprise means for performing modification of a network element or link settings including allocated in-flight capacity, content validity periods, network connections, network connection bandwidth, or quality-of-service parameters.

64. The framework as claimed in claim 35, wherein the collecting means comprises an interface for receiving network element transactional data including call detail record (CDR) streams.

65. The framework as claimed in claim 35, wherein the collecting means comprises an interface for receiving network performance objects containing information concerning network element utilisation, including SNMP performance objects.

66. The framework as claimed in claim 35, wherein the collecting means comprises an interface for receiving network performance objects containing information concerning network element utilisation, including SNMP performance objects; and wherein the collecting means comprises an interface for receiving network element monitoring information.

67. The framework as claimed in claim 35, wherein the collecting means comprises means for receiving real time data feeds.

68. A method performed in a communication network having a service delivery infrastructure with network elements providing services to subscribers, the method comprising the steps of:
collecting service delivery data from the network;
analysing said data by performing the steps of:
performing, using subscriber profiles, subscriber segmentation to generate segmentation models representing behavioural characteristics of subscribers,
deriving service predictive models from said segmentation models and collected network infrastructure data, said service predictive models correlating service demand levels and network infrastructure utilisation, and
determining in response to said predictive models actions to dynamically and pre-emptively modify the service delivery infrastructure of the network to optimise service delivery; and
performing said actions.

69. A computer readable medium comprising software code for performing the following steps when executing on one or more digital processors in a communication network having a service delivery infrastructure with network elements providing services to subscribers, said steps including:
collecting service delivery data from the network;
analysing said data by performing the steps of:
performing, using subscriber profiles, subscriber segmentation to generate segmentation models representing behavioural characteristics of subscribers,
deriving service predictive models from said segmentation models and collected network infrastructure data, said service predictive models correlating service demand levels and network infrastructure utilisation, and
determining in response to said predictive models actions to dynamically and pre-emptively modify the service delivery infrastructure of the network to optimise service delivery; and performing said actions.
